(19) United States
(12) Patent Application Publication
(10) Pub. No.: US 2023/0354827 A1
(43) Pub. Date: Nov. 9, 2023

(54) HORIZONTAL AND RADIAL AIRFLOW HEAT TRANSFER SYSTEM

(71) Applicant: FPS Food Process Solutions Corp., Richmond (CA)

(72) Inventor: Kin Hung Jeffrey Chang, Richmond (CA)

(21) Appl. No.: 18/027,307

(22) PCT Filed: Sep. 8, 2021
(86) PCT No.: PCT/CA2021/051236

§ 371 Date: Mar. 20, 2023

Related U.S. Application Data
(60) Provisional application No. 63/081,090, filed on Sep. 21, 2020.

(51) Int. Cl. A21B 1/48; A21B 1/26

(52) U.S. Cl. CPC A21B 1/48; A21B 1/26

(57) ABSTRACT

A heat transfer system includes a conveyor belt having air permeable outer and inner side walls and forming a conveyor stack having a plurality of tiers and a central space with a volume. A first portion of the volume and a first plurality of tiers are in a first sub-chamber and a second portion of the volume and a second plurality of tiers are in a second sub-chamber. The system further includes generating means which: produces, in the second sub-chamber, airflow in a horizontal direction towards the conveyor stack and in a horizontal and radial direction across the second plurality of tiers to enter the second portion of the volume; and draws, in the first sub-chamber, the airflow in a horizontal direction away from the conveyor stack and in a horizontal and radial direction to exit the first portion of the volume across the first plurality of tiers.

### PRIORITY CLAIM

This application is a national stage application of PCT/CA2021/051236, filed on Sep. 8, 2021, which claims the benefit of and priority to U.S. Provisional Patent Application No. 63/081,090, filed on Sep. 21, 2020, the entire contents of which are each incorporated by reference herein.

### FIELD

This disclosure generally relates to a system far altering a temperature of a product carried by a conveyor belt with airflow. This disclosure more particular relates to a system for generating and directing horizontal and radial airflow through a conveyor stack formed by the conveyor belt to alter the temperature of the product carried by the conveyor belt.

### BACKGROUND

Conveyor belts are typically used for conveying bulk products, such as foodstuffs, that must be transported through a cooled or heated environment. In such applications, it is often desirable to maximize the time of transport within the cooled or heated environment and transport goods along a extend travel path of travel. Stacked conveyor belts (such as spiral conveyor belts) include conveyor belts which form conveyor stacks having a plurality of tiers which are stacked on top of each other and may transport the bulk products along an extended travel path while utilizing minimal floor space. Further, self-stacking conveyor belts may provide an extended travel path with minimal framing. A self-stacking conveyor belt uses side plates coupled to side edges of a central portion of the conveyor belt to form a self-supporting stack having a plurality of tiers, with lower tiers of the plurality of tiers being supported by a frame, but the upper tiers of the plurality of tiers being supported directly by the lower tiers. The interface between stacked tiers of the plurality of tiers are generally designed to keep the portion of the conveyor belt within the self-supporting stack supported and laterally aligned, and may include guards and other align.

In conveyor systems utilizing stacked conveyor belts, there are generally two different types of airflow used to cool or heat product carried by the conveyor belt. The first type is vertical airflow, which involves forcing airflow from either the ceiling or the floor through the stack of the conveyor belting and out the opposite end (floor or ceiling). The second type is horizontal airflow, which involves airflow entering from one side of the conveyor stack and exiting out of the other side of the conveyor stack so that the airflows horizontally across the conveyor belts.

However, utilizing vertical airflow can result in loss of pressure as the airflow travels through the different tiers of the conveyor stack, which may result in less efficient cooling or heating. This loss of pressure can be particularly acute in large conveyor systems utilizing conveyor belts stacked into a large plurality of tiers. Further, stacking conveyor belts, and particularly self-stacking conveyor belts, often prevent adequate horizontal airflow. Further still, horizontal airflow is typically generated on only one side of the conveyor stack, so the side of The conveyor stack proximate the horizontal airflow generator will receive more airflow than the other side of the conveyor stack distant from the horizontal air flow generator, resulting in lower performance.

### SUMMARY

In one embodiment, there is provided a heat transfer system for altering a temperature of product with airflow. The system includes a conveyor belt for carrying the product. The conveyor belt has an air permeable outer side wall and an air permeable inner side wall and forms a conveyor stack having a plurality of tiers and a central space with a volume. The conveyor stack is positioned in a chamber such that a first portion of the volume of the central space and a first plurality of tiers of the plurality of tiers is located in a first sub-chamber of the chamber and a second portion of the volume of the central space and a second plurality of tiers of the plurality of tiers is located in a second sub-chamber of the chamber. The system further includes generating means for generating the airflow in the chamber. The generating means is configured to: produce, in the second sub-chamber, the airflow in a horizontal direction towards the conveyor stack, such that the airflow flows in a horizontal and radial direction across the second plurality of tiers to enter the second portion of the volume of the central space; and draw, in the first sub-chamber, the airflow in a horizontal direction away from the conveyor stack, such that the airflow flows in a horizontal and radial direction to exit the first portion of the volume of the central space across the first plurality of tiers.

In another embodiment, there is provided a method of assembling a heat transfer system for altering a temperature of products using airflow. The method involves positioning a conveyor stack formed by a plurality of tiers of a conveyor belt for carrying the product, the conveyor belt including an air permeable outer side wall and an air permeable inner side wall and the conveyor stack having a central space with a volume, in a chamber such that a first portion of the volume of the central space and a first plurality of tiers of the plurality of tiers is located in a first sub-chamber of the chamber and a second portion of the volume of the central space and a second plurality of tiers of the plurality of tiers is located in a second sub-chamber of the chamber. The method further involves positioning generating means for generating the airflow in the chamber proximate the conveyor stack. The generating means is operably configured to: produce, in the second sub-chamber, the airflow in a horizontal direction towards the conveyor stack, such that the airflow flows in a horizontal and radial direction across the second plurality of tiers to enter the second portion of the volume of the central space; and draw, in the first sub-chamber, the airflow in a horizontal direction away from the conveyor stack, such that the airflow flows in a horizontal and radial direction to exit the first portion of the volume of the central space across the first plurality of tiers.

In another embodiment, there is provided a method of altering a temperature of product carried on a conveyor belt having an air permeable outer side wall and an air permeable inner side wall and forming a conveyor stack having a plurality of tiers and a central space with a volume. The conveyor stack is positioned in a chamber. The method involves producing, in a second sub-chamber of the chamber, the airflow in a horizontal direction towards the conveyor stack, such that the airflow flows in a horizontal and radial direction across a second plurality of tiers of the plurality of tiers to enter a second portion of the volume of the central space. The method further involves drawing, in a first sub-chamber of the chamber, the airflow in a horizontal direction away from the conveyor stack, such that the airflow flows in a horizontal and radial direction to exit a first portion of the volume of the central space across a first plurality of tiers of the plurality of tiers.

Other aspects and features of the present disclosure will become apparent to those ordinarily skilled in the art upon review of the following description of specific embodiments of the disclosure in conjunction with the accompanying Figures.

### BRIEF DESCRIPTION OF THE DRAWINGS

Further features and advantages of the present disclosure will be apparent from the following description of a non-limiting embodiment thereof, with reference to the Figures of the accompanying drawings, wherein:

FIG. 1 is an elevation view of a heat transfer system in accordance with one embodiment.

FIG. 2 is a perspective view of a conveyor system of the heat transfer system in FIG. 1 in accordance with one embodiment.

FIG. 3 is a perspective view of a belt module of a conveyor belt of the conveyor system shown in FIGS. 1 and 2 in accordance with one embodiment.

FIGS. 4A and 4B are, respectively, a cross-sectional plan view of the heat transfer system of FIG. 1 at line 4-4 in a second sub-chamber and an elevation view of airflow across the belt module of FIG. 3 in the second sub-chamber in accordance with one embodiment.

FIGS. 5A and 5B are, respectively, a cross-sectional plan view of the heat transfer system of FIG. 1 at line 5-5 in a first sub-chamber and an elevation view of airflow across the belt module of FIG. 3 in the first sub-chamber in accordance with one embodiment.

FIG. 6 is a perspective view of a driving drum which may engage a conveyor stack of the conveyor system shown in FIGS. 1 and 2 in accordance with one embodiment.

### DETAILED DESCRIPTION

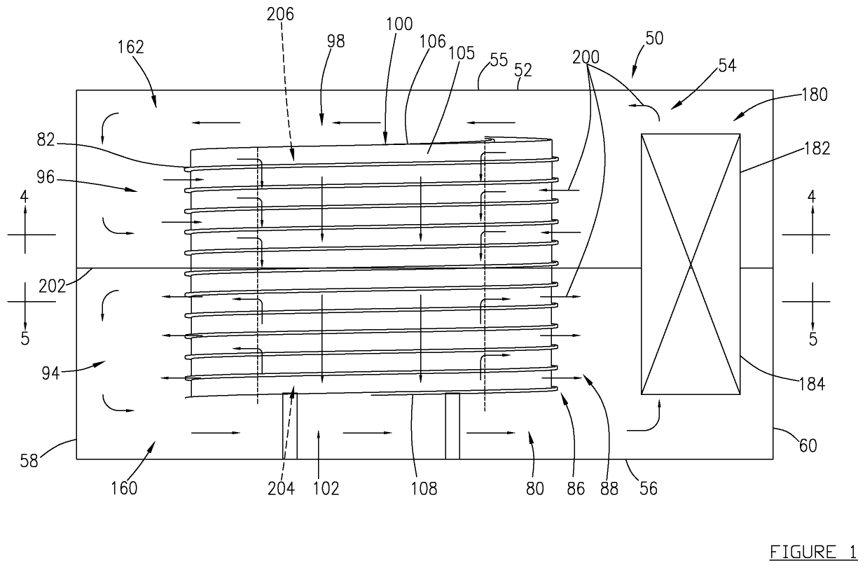

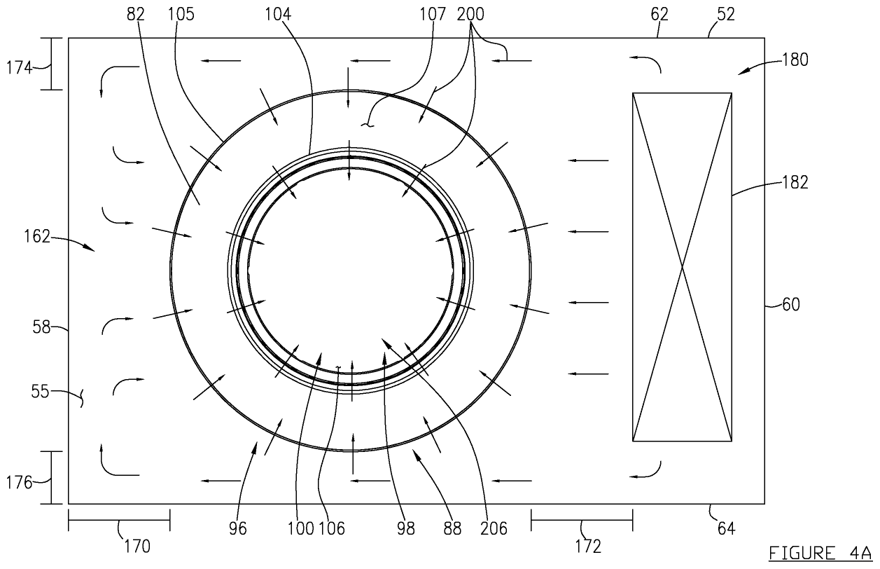

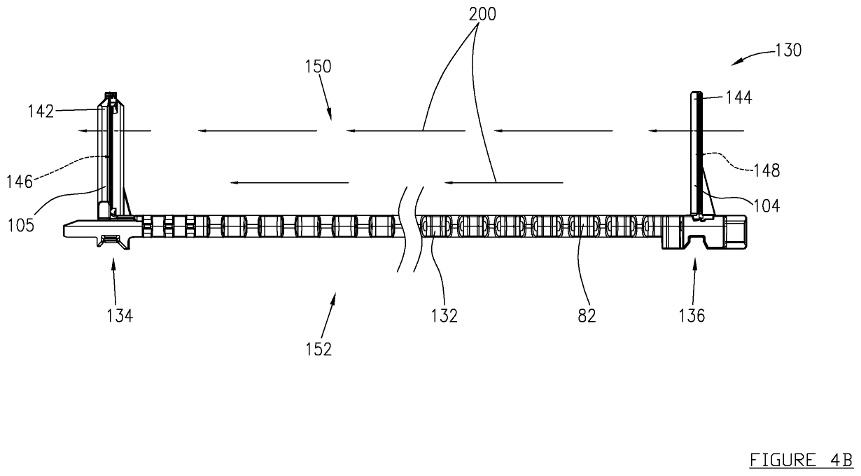

Referring to FIG. 1, a radial and horizontal airflow heat transfer system is shown generally at 50. The heat transfer system 50 is used to cool, freeze, heat, dry, bake or otherwise cook products (not shown), such as food products or plant products. The heat transfer system 50 includes a housing 52 with an internal cavity or chamber 54. The housing 52 is constructed of any suitable material for cooling, freezing, heating, drying, baking or cooking applications within the chamber 54. In the embodiment shown in FIG. 1, the housing 52 includes a top wall 55, bottom wall 56, first end wall 58, second end wall 60, a first side wall 62 (shown in FIG. 4A) and a second side wall 64 (shown in FIG. 4A). Other embodiments may include fewer or more walls. The walls 55, 56, 58, 60, 62 and 64 are substantially impermeable to air such that airflow 200 generated by generating means 180 or generator (described in greater detail below) of the heat transfer system 50 deflects from the walls 55, 56, 58, 60, 62, 64 upon contact with the walls 55, 56, 58, 60, 62, 64 and remains in the chamber 54.

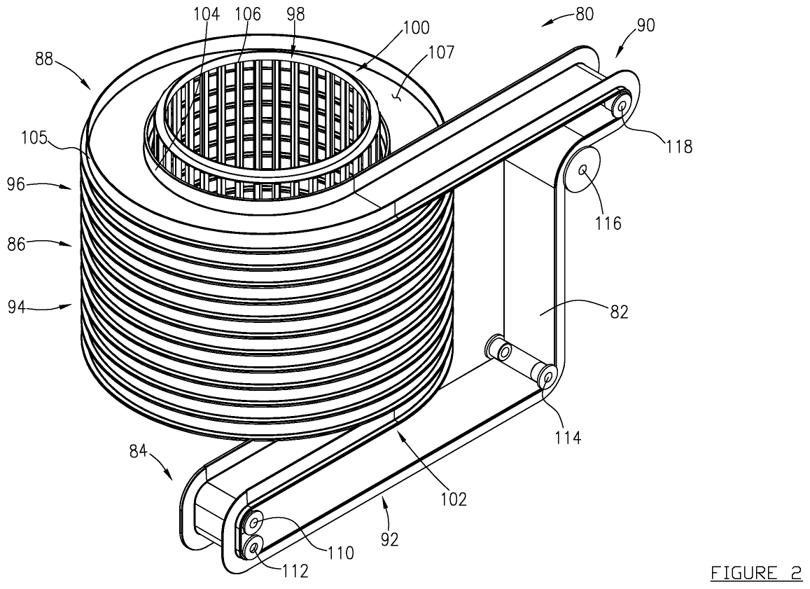

The heat transfer system 50 also includes a conveyor system 80 including a conveyor belt 82. The conveyor belt 82 includes an air permeable inner side wall 104, an air permeable outer side wall 105 and a conveying portion 107 extending between the inner side wall 104 and the outer side wall 105 configured to carry product. In certain embodiments, the conveying portion 107 may be restrict airflow in a vertical direction through the conveying portion 107. Referring to FIGS. 1 and 2, the conveyor belt 82 may be an endless conveyor belt having a travel path from a lower input 84 where product is placed onto the conveyor belt 82, to a plurality of turns of the conveyor belt 82 forming a conveyor stack 88 having a plurality of tiers 86, and then to an upper output 90 where product is removed from the conveyor belt 82. In the embodiment shown in FIGS. 1 and 2, the conveyor stack 88 is a spiral helical stack, and the travel path of the conveyor belt 82 through the conveyor stack 88 comprises a helical travel path. In other embodiments (not shown), the conveyor stack 88 may be stacked in a different configuration.

The conveyor stack 88 includes a volume of a central space 98 having a top opening 100 and a bottom opening 102, and having a lateral surface generally defined by the inner wall 104 of the conveyor belt 82. The top opening 100, the bottom opening 102 and the inner wall 104 may define the volume of the central space 98. In the embodiment shown in FIG. 1, the heat transfer system 50 further includes a top end wall 106 positioned at the top opening 100 of the conveyor stack 88 and which is configured to substantially restrict airflow into or out of the volume of the central space 98 through the top opening 100. The heat transfer system 50 further includes a bottom end wall 108 positioned at the bottom opening 102 of the conveyor stack 88 and which is configured to substantially restrict airflow into and out of the volume of the central space 98 through the bottom opening 102. In other embodiments (not shown), the heat transfer system 50 may not include at least one of the top end wall 106 and the bottom end wall 108.

As noted above, the travel path of the conveyor belt 82 involves the conveyor belt 82 being fed into the conveyor stack 88 from the lower input 84 and being fed out of the conveyor stack 88 from the upper output 90. However, in other embodiments (not shown), this configuration may be reversed, such that the travel path of the conveyor belt 82 may be fed into the conveyor stack 88 from the upper output 90 and may he fed out of the conveyor stack 88 from the lower input 84. In certain embodiments (not shown), the lower input 84 and the upper output 90 may be located within the chamber 54, such that the entire conveyor system 80 (shown in FIG. 2) is located entirely within the chamber 54. In other embodiments, the lower input 84 and the upper output 90 may be located outside of the chamber 54, such that only the conveyor stack 88 of the conveyor system 80 is located entirely within the chamber 54. For example, the lower input 84 maybe positioned on an outer side of the first end wall 58 of the housing 52 and the upper output 90 may be positioned on an outer side of the second end wall 60 of the housing 52, or both The lower input 84 and the upper output 90 may be positioned on an outer side of the first side wall 62 of the housing 52.

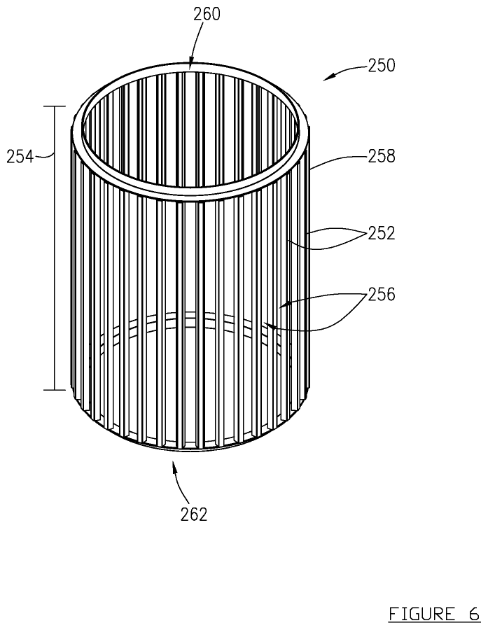

Still referring to FIGS. 1 and 2, the conveyor belt 82 may be a self-stacking conveyor belt, such that each tier of the plurality of tiers 86 of the conveyor stack 88 arc stacked serially and directly on top of a previous tier of the plurality of tiers 86. As such, the conveyor belt 82 may be configured to rotate and convey products vertically along the travel path and through the conveyor stack 88 without a central driving drum positioned within the central space 98 of the conveyor stack 88. Referring to FIG. 2, the conveyor belt 82 maybe fed around rollers 110 and 112 proximate the lower input 84, roller 114 proximate the linking portion 92, and rollers 116 and 118 proximate the upper output 90. The rollers 110, 112, 114, 116 and 118 may drive the conveyor belt 82 along the travel path and through the conveyor stack 88. In this respect, the rollers 110, 112, 114, 116 and 118 may be associated with sprockets having a motor to drive the movement of the conveyor belt 82 along the travel path of the conveyor belt 82. In other embodiments (not shown), the conveyor belt 82 maybe driven by more or fewer rollers, and such rollers may be located at different locations along the conveyor belt 82. In yet other embodiment, the conveyor system 80 may include a central driving drum (described in greater detail below in association with FIG. 6) located within the central space 98 of the conveyor stack 88 and which engages the inner side wall 104 of the conveyor belt 82 to rotate the conveyor belt 82 through the conveyor stack 88 and along the travel path of the conveyor belt 82. Utilizing a combination of the central driving drum with rollers (such as the rollers 110, 112, 114, 116 and 118) may result in more rapid rotation of the conveyor belt 82 through the conveyor stack 88, and more rapid travel of the conveyor belt 82 along the travel path of the conveyor belt 82.

In other embodiments (not shown), the conveyor belt 82 maybe a different type of conveyor belt, such as a platform-supported or wearstrip-supported conveyor belt having a support platform or wear strip under each tier of the plurality of tiers 86. Such embodiments of the conveyor system 80 generally include the central driving drum located within the central space 98 of the conveyor stack 88. In embodiments where the conveyor system 80 includes a central driving drum to rotate the conveyor belt 82 along the travel path and the conveyor stack 88, such central driving drums generally include a lateral wall which is substantially air permeable (described in greater detail below in association with FIG. 6) to cooperate with the air permeable configuration of the inner and outer side walls 104 and 105 of the conveyor belt 82 to facilitate airflow in a horizontal and radial direction across the conveyor stack 88 and in a horizontal and radial direction to enter and exit the volume of the central space 98.

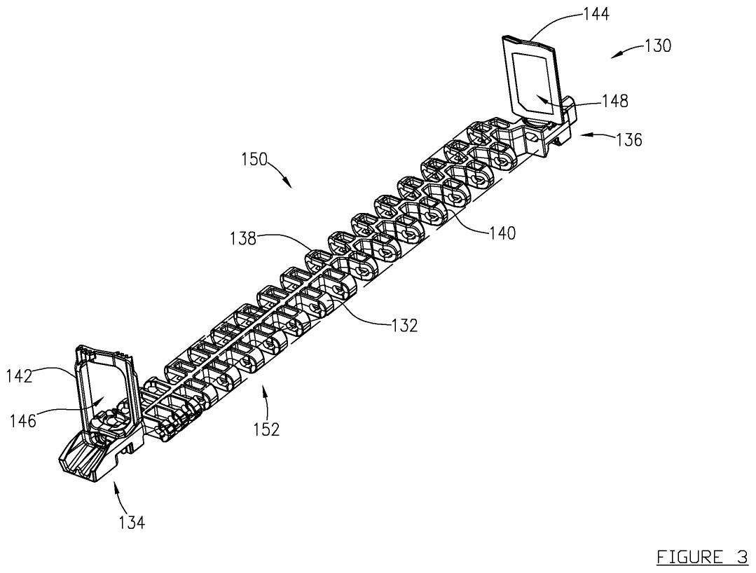

The conveyor belt 82 may be constructed of a series of belt modules, where in each belt module may be similar to belt module 130 shown in FIG. 3 for example. The belt module 130 includes a central portion 132 laterally extending between an inner side 134 of the conveyor belt 82 and an outer side 136 of the conveyor belt 82. The central portion 132 may include connector elements (not shown) configured to connect one belt module 130 to an adjacent belt module to form the conveyor belt 82. For example, the central portion 132 may include grooves and protrusions (not shown) on both a leading edge 138 of the central portion 132 and a trailing edge 140 of the central portion 132. The grooves may be configured to receive corresponding protrusions of a central portion of an adjacent belt module, and the protrusions may be configured for insertion into corresponding grooves of the central portion of the adjacent belt module to couple the belt module 130 to an adjacent belt module. Additionally, the protrusions of the central portion 132 of the belt module 130 may include openings which align when the protrusions are received in the corresponding grooves of adjacent belt modules, and the aligned openings may be configured to receive a rod element to more securely couple adjacent belt modules. At least one of the openings proximate the inner side 134 of the conveyor belt 82 or protrusions proximate the outer side 136 of the conveyor belt 82 may be elongated longitudinally to allow the conveyor belt 82 to collapse and expand while the conveyor belt 82 is traveling through the conveyor stack 88.

The belt module 130 further includes an inner side plate 142 and an outer side plate 144. The inner side plate 142 is coupled to the central portion 132 proximate the inner edge 134 of the conveyor belt 82 and the outer side plate 144 is coupled to the central portion 132 proximate the outer edge 136 of the conveyor belt 82. The inner side plates 142 of coupled adjacent belt modules 130 generally form the inner side wall 104 of the conveyor belt 82 and generally defines the lateral surface of the volume of the central space 98 of the conveyor stack 88. The outer side plates 144 of coupled adjacent belt modules 130 generally form the outer side wall 105 (shown in FIGS. 1 and 2) of the conveyor belt 82.

The inner and outer side plates 142 and 144 are configured to facilitate horizontal airflow around product conveyed by the conveyor belt 82, such as product placed on the central portion 132 of the belt module 130. In this respect, the inner and outer side plates 142 and 144 may be made from a material or have a configuration which provide the inner and outer side walls 104, 105 of the conveyor belt 82 with a substantially air permeable configuration, to enable to enable airflow in a horizontal and radial direction through the outer side wall 105 and then the inner side wall 104 of the conveyor belt 82 to enter the volume of the central space 98 of the conveyor stack 88, and to enable the airflow in a horizontal and radial direction to exit the volume of the central space 98 of the conveyor stack 88 through the inner side wall 104 and then the outer side wall 105 of the conveyor belt 82. For example, in the embodiment shown in FIG. 3, the inner side plate 142 includes at least one aperture 146 and the outer side plate 144 includes a corresponding at least one aperture 148. The at least one apertures 146 and 148 facilitate horizontal airflow across the central portions 132 of coupled belt modules 130, to heat or cool the product carried on the central portions 132 of the belt modules 130, and facilitate airflow in the horizontal and radial direction into or out of the volume of the central space 98. Additionally, movement of successively coupled belt modules 130 while the conveyor belt 82 is travelling up the conveyor stack 88 may cause play between adjacent side plates 142, 144 (and particular between adjacent outer side plates 144, as a circumference of the outer side wall 105 of the conveyor stack 88 formed by adjacent outer side plates 144 is generally larger than the circumference of the inner side wall 104 of the conveyor stack 88 formed by adjacent inner side plates 142) causing spaces to open between the adjacent side plates 142, 144 which enables airflow through such spaces.

Horizontal airflow across the central portions 132 of the belt modules 130 (ie. airflow from the outer side wall 105 to the inner side wall 104 of the conveyor belt 82, and vice versa) may further be facilitated by the configuration of the central portion 132. In certain embodiments, the central portion 132 may be configured to substantially restrict airflow vertically through the central portion 132, such as restrict the airflow vertically from an upper side 150 of the belt module 130 to a lower side 152 of the belt module 130, thus substantially restricting airflow in a vertical direction between different tiers of the plurality of tiers 86 of the conveyor stack 88. For example, the central portion 132 may be made of a solid material, or have a solid configuration, which is substantially air impermeable, such that the airflow 200 contacting the central portion 132 is substantially deflected by the central portion 132. In other embodiments, the central portion 132 may not restrict airflow in the vertical direction through the central portion 132 and may allow some airflow from the upper side 150 to the lower side 152 of the belt module 130. In such embodiments, the central portion 132 may be made of a material or have configuration which is substantially air permeable, and may be made of a mesh material or other perforated material for example.

Referring back to FIG. 1, the conveyor stack 88 of the conveyor belt 82 is located entirely within the chamber 54. Referring briefly to FIGS. 4A and 4B, the conveyor stack 88 may be located substantially centrally in the chamber 54 relative to the generating means 180 (described in greater detail below), such that a closest distance 170 between the first end wall 58 of the housing 52 and the outer side wall 105 of the conveyor belt 82 in the conveyor stack 88 is substantially equal to a closest distance 172 between an airflow outlet of the generating means 180 and the outer side wall 105 of the conveyor belt 82 in the conveyor stack 88. Further, the conveyor stack 88 may be located in the chamber 54 such that a closest distance 174 between the first side wall 62 of the housing 52 and the outer wall 105 of the conveyor belt 82 in the conveyor stack 88 is substantially equal to a closest distance 176 between the second side wall 64 and the outer wall 105 of the conveyor belt 82 in the conveyor stack 88. In yet other embodiments (not shown), the closest distances 170, 172, 174 and 176 may all be substantially equal. The central location of the conveyor stack 88 in the chamber 54 may facilitate directing the airflow substantially evenly in the horizontal and radial direction into and out of the conveyor stack 88 and the volume of the central space 98.

Still referring to FIG. 1, the chamber 54 may be divided into a first sub-chamber 160 and a second sub-chamber 162. The first and second sub-chambers 160 and 162 may be defined and separated by a baffle 202.

The plurality of tiers 86 of the conveyor stack 88 includes a first plurality of tiers 94 (comprising lower tiers proximate the lower input 84 (shown in FIG. 2)) and a second plurality of tiers 96 (comprising the upper tiers proximate the upper output 90 (shown in FIG. 2)). The first plurality of tiers 94 of the conveyor stack 88 may be located substantially entirely within the first sub-chamber 160, and the second plurality of tiers 96 of the conveyor stack 88 may be located substantially entirely within the second sub-chamber 162. In embodiments where the travel path of the conveyor belt 82 moves from the lower input 84, through the conveyor stack 88 and then to the upper output 90, product carried by the conveyor belt 82 is moved from the first plurality of tiers 94 into the second plurality of tiers 96 and is thus moved from the first sub-chamber 160 to the second sub-chamber 162 as the conveyor belt 82 moves through the travel path of the conveyor belt 82. In embodiments where the travel path of the conveyor belt 82 is reversed and moves from the upper output 90, through the conveyor stack 88, and then to the lower input 84, product carried by the conveyor belt 82 is moved from the second plurality of tiers 96 to the first plurality of tiers 94, and is thus moved from the second sub-chamber 162 to the first sub-chamber 160 as the conveyor belt 82 moves through the travel path of the conveyor belt 82.

Similarly, the volume of the central space 98 of the conveyor stack 88 may include a first portion 204 (generally corresponding to a lower portion of the volume) and a second portion 206 (generally corresponding to an upper portion of the volume). The first portion 204 of the volume of the central space 98 may be located entirely within the first sub-chamber 160 and the second portion 206 of the volume of the central space 98 may be located entirely within the second sub-chamber 162.

Still referring to FIG. 1, the heat transfer system 50 further includes the generating means 180. In the embodiment shown, the generating means 180 includes an airflow producing means 182 or airflow producer configured to produce and direct the airflow 200, which may be cooled or heated airflow, towards the second plurality of tiers 96 of the conveyor stack 88 in the second sub-chamber 162. The airflow producing means 182 may be any means designed to produce the airflow 200 from at least one air outlet of the airflow producing means 182 and direct the airflow 200 towards the conveyor stack 88 in a substantially horizontal direction. For example, the airflow producing means 182 may be a fan, blower, compressor or any other suitable means for producing the airflow 200 in the substantially horizontal direction. The airflow producing means 182 may be entirely located in the second sub-chamber 162.

The generating means 182 further includes an airflow drawing means 184 or airflow drawer configured to draw the airflow 200 away from the first plurality of tiers 94 of the conveyor stack 88 in the first sub-chamber 160. The airflow drawing means 184 may be any means configured to draw the airflow 200 away from the conveyor stack 88 and to direct the airflow 200 towards at least one air inlet of the airflow drawing means 184 in a substantially horizontal direction. For example, the airflow drawing means 184 may be a vacuum or other suction means, or any other suitable means for drawing the airflow 200 in the substantially horizontal direction. The airflow drawing means 184 may be located entirely within the first sub-chamber 160.

As noted above, in the embodiment shown in FIG. 1, the airflow producing means 182 may be configured to produce and direct the airflow 200 towards the conveyor stack 88 in the second sub-chamber 160, whereas the airflow drawing means 184 may be configured to draw the airflow 200 away from the conveyor stack 88 in the first sub-chamber 160. However, in other embodiments (not shown), this configuration may be reversed. For example, in other embodiments, the airflow producing means 182 may be configured to produce and direct the airflow 200 towards the conveyor stack 88 in the first sub-chamber 160, whereas the airflow generating means 184 may be configured to draw the airflow 200 away from the conveyor stack 88 in the second sub chamber 162. In such embodiments, the location of the airflow producing means 182 and the airflow drawing means 184 may also be reversed. For example, the air flow producing means 182 may be entirely located in the first sub-chamber 160, whereas the airflow drawing means 184 may be located entirely within the second sub-chamber 162.

In the embodiment shown in FIG. 1, the baffle 202 may be substantially continuous around the plurality of tiers 86 of the conveyor stack 88 and the generating means 180, extending generally throughout the chamber 54 from the first end wall 58 to the second end wall 60 of the housing 52.

As noted above, the baffle 202 divides the chamber 54 into the first sub-chamber 160 and the second sub-chamber 162, and may be configured to substantially restrict the airflow 200 in a vertical direction directly between the first sub-chamber 160 and the second sub-chamber 162. The baffle 202 also divides the second plurality of tiers 96 of the conveyor stack 88 from the first plurality of tiers 94 of the conveyor stack 88, and may be configured to substantially restrict airflow directly between an interface of the second plurality of tiers 96 and the first plurality of tiers 94. For example, the baffle 202 may substantially restrict the airflow 200 in a vertical direction through the conveyor stack 88, between the inner side wall 104 and the outer side wall 105 of the conveyor belt 82, at the interface between the first plurality of tiers 94 and the second plurality of tiers 96. To accomplish the restriction of the airflow 200 in the vertical direction described above, the baffle 202 may primarily be made of a material, or may primarily have a configuration, which is substantially air impermeable such that the airflow 200 contacting the baffle 202 is substantially deflected by the baffle 202. However, portions of the baffle 202 may be made of a material, or have a configuration, which is air permeable. For example, proximate the conveyor stack 88, the baffle 202 may have at least one opening which allows the conveyor belt 82 to move between the first plurality of tiers 94 located in the first sub-chamber 160 and the second plurality of tiers 96 located in the second sub-chamber 162. Further, proximate the generator means 180, the baffle 202 may have an opening configured to receive the generator means 180, or a portion which allows the airflow producing means 182 to generate the airflow 200 from the at least one air outlet into the second sub-chamber 162 or a portion which allows the airflow drawing means 184 to draw the airflow 200 from the first sub-chamber 160 into the at least one air inlet. In certain embodiments (not shown), the baffle 202 may comprise a mezzanine deck which is capable of supporting at least one individual, such as an operator for example.

The baffle 202 may be configured to stop at the inner side wall 104 of the conveyor belt 82 forming the conveyor stack 88 and may not extend within the volume of the central space 98 of the conveyor stack 88. The baffle 202 thus does not restrict the airflow 200 in a vertical direction between the second portion 206 of the volume of the central space 98 in the first sub-chamber 160 and the first portion 204 of the volume of the central space 98 in the second sub-chamber 162. The baffle 202 may thus substantially restrict the airflow 200 in a vertical direction directly between the second sub-chamber 162 and the first sub-chamber 160 except within the volume of the central space 98.

Further, as noted above, in certain embodiments, the conveyor belt 82 may be configured (such as due to the material or configuration of the central portion 132 of the belt modules 130 (shown in FIG. 3) forming the conveyor belt 82 being substantially air impermeable for example) to restrict airflow vertically through the conveyor stack 88 between the tiers of the first plurality of tiers 94 and between the tiers of the second plurality of tiers 96. In such embodiments, the material or configuration of the central portion 132 of the belt module 130 substantially restrict the airflow 200 in a vertical direction through the conveyor stack 88 even within the second sub-chamber 162 and through the conveyor stack 88 even within the first sub-chamber 160, rather than merely between the first and second sub-chambers 160 and 162. Further, in such embodiments, the baffle 202 may cooperate with the material or configuration of the central portion 132 of the belt module 130 to substantially restrict the airflow 200 in the vertical direction throughout the entire conveyor stack 88.

In other embodiments, the conveyor belt 82 may be configured (such as due to the material or configuration of the central portion 132 of the belt modules 130 (shown in FIG. 3) forming the conveyor belt 82 being substantially air permeable for example) to allow the airflow 200 in the vertical direction through the conveyor stack 88 between the tiers of the first plurality of tiers 94 and between the tiers of the second plurality of tiers 96. In such embodiments, the material or configuration of the central portion 132 of the belt module 130 may allow the airflow 200 in a vertical direction through the conveyor stack 88 within the second sub-chamber 162 and through the conveyor stack 88 the first sub-chamber 160, but the baffle 202 may restrict the airflow 200 in the vertical direction through the conveyor stack 88 between the second sub-chamber 162 and the first sub-chamber 160.

Referring now to FIGS. 1, 4A, 4B, 5A and 5B, different features and elements of the heat transfer system 50 may facilitate directing the airflow 200 in a horizontal and radial direction across the conveyor stack 88 and in a horizontal and radial direction to enter and exit the volume of the central space 98. As will be described in greater detail below, at least one of: the configuration of the belt module 130 (shown in FIG. 3), the top end wall 106 positioned at the top opening 100 of the conveyor stack 88, the bottom end wall 108 positioned at the bottom opening 102 of the conveyor stack 88, the baffle 202, the airflow producing means 182 in the second sub-chamber 162, the airflow drawing means 184 in the first sub-chamber 160, and the central placement of the conveyor stack 88 within the chamber 54, may cooperate to:
direct the airflow 200, produced from the airflow producing means 182 and in the second sub-chamber 162, in a horizontal direction towards the conveyor stack 88 and in a horizontal and radial direction into the conveyor stack 88,
direct the airflow 200, in the conveyor stack 88 in second sub-chamber 162, in a horizontal and radial direction across the second plurality of tiers 96 of the conveyor stack 88 to enter the second portion 206 of the volume of the central space 98,
direct the airflow 200 in a vertical direction from the second portion 206 of the volume of the central space 98 (in the second sub-chamber 162) towards the first portion 204 of the volume of the central space 98 (in the first sub-chamber 160),
direct the airflow 200, in the first portion 204 of the volume of the central space 98 and in the first sub-chamber 160, in a horizontal and radial direction to exit the first portion 204 of the volume of the central space 98, and
direct the airflow 200, in the conveyor stack 88 in the first sub-chamber 160, in a horizontal and radial direction across the first plurality of tiers 94 of the conveyor stack 88 and to exit the conveyor stack 88 in a horizontal direction towards the airflow drawing means 184.

Referring to FIGS. 4A and 4B. a cross-sectional view of the heat transfer system 50 of FIG. 1 at line 4-4 is shown in FIG. 4A, and path of travel of the airflow 200 across a belt module 130 (described in greater detail above in association with FIG. 3) of the conveyor belt 82 located in the second sub-chamber 162 (such as located within a tier of the second plurality of tiers 96 of the conveyor stack 88) is shown in FIG. 4B.

Referring to FIGS. 1 and 4A, within the second sub-chamber 162, the airflow 200 is initially produced by the airflow producing means 182 or airflow producer and is directed by the airflow producing means 182 from the at least one air outlet of the airflow producing means 182 in a horizontal direction towards the conveyor stack 88. Directing the airflow 200 in the horizontal direction towards the conveyor stack 88 may primarily be due to the production of the airflow 200 in the horizontal direction by the airflow producing means 182. However, in certain embodiments, directing the airflow 200 in the horizontal direction towards the conveyor stack 88 may also be facilitated by at least one of the following features and elements of the heat transfer system 50:

Placement of the airflow producing means 182 in the second sub-chamber 162 (which generates a positive air pressure in the second sub-chamber 162) in combination with placement of the airflow drawing means 184 in the first sub-chamber 160 (which generates a negative air pressure in the first sub-chamber 160), which can create a pressure differential between the second sub-chamber 162 and the first sub-chamber 160. The pressure differential may cause the airflow 200 to seek a path of travel from the second sub-chamber 162 to the first sub-chamber 160.

Certain portions of the airflow 200 generated by the airflow producing means 182 may flow past the conveyor stack 88 to contact the first end wall 58 of the housing 52, certain other portions of the airflow 200 may flow to contact the first side wall 62 and the second side wall 64 of the housing 52, and certain other portions of the airflow 200 may flow to contact the top wall 55 of the housing 52. However, as noted above, the airflow 200 contacting the walls 58, 62, 64 and 55 may be substantially deflected back towards the conveyor stack 88.

Central placement of the conveyor stack 88 within the chamber 54 may cause even deflection of the airflow 200 back towards the conveyor stack 88. In particular, the closest distance 174 between the first side wall 62 and the conveyor stack 88 is substantially equal to the closest distance 176 between the second side wall 64 and the conveyor stack 88. As such, the volume and rate of deflection of the airflow 200 contacting the first side wall 62 and the second sidewall 64 back towards the conveyor stack 88 maybe substantially equal, which may facilitate even deflection of the airflow 200 in the horizontal direction towards the conveyor stack 88.

The top end wall 106 positioned at the top opening 100 of the conveyor stack 88 and configured to substantially restrict the airflow 200 in a vertical direction through the top opening 100. The top end wall 106 may cause certain portions of the airflow 200 in the second sub-chamber 162 which flow to contact the top end wall 106 to be deflected back into the second sub-chamber 162 such as towards the top wall 55 of the housing 52 for example. The top end wall 106 may also restrict the airflow 200 from entering the volume of the central space 98 directly from the second sub-chamber 162. Deflecting the airflow 200 back into the second sub-chamber 162 and preventing the airflow 200 from entering the volume of the central space 98 directly from the second sub-chamber 162 can facilitate directing the airflow 200 in the horizontal direction towards the conveyor stack 88, as the airflow 200 seeks alternate paths of travel from the second sub-chamber 162 towards the first sub-chamber 160.

The baffle 202 configured to substantially restrict the airflow 200 directly between the second sub-chamber 162 and the first sub-chamber 160. Certain portions of the airflow 200 in the second sub-chamber 162 which flow to contact the baffle 202 may be deflected back into the second sub-chamber 162, such as towards the top wall 55 of the housing 52 for example. Deflecting the airflow 200 back into the second sub-chamber 162 and preventing the airflow 200 from entering the first sub-chamber 160 directly from the second sub-chamber 162 except within the volume of the central space 98, can facilitate directing the airflow 200 in the horizontal direction towards the conveyor stack 88, as the airflow 200 seeks alternate paths of travel from the second sub-chamber 162 towards the first sub-chamber 160.

Referring to FIGS. 1, 4A and 4B, at least a portion of the airflow 200 produced by the airflow producing means 182 and within the second sub-chamber 162 is then directed in a horizontal and radial direction to enter the conveyor stack 88 through the outer side wall 105 of the conveyor belt 82. Directing the airflow 200 in the horizontal and radial direction to enter the conveyor stack 88 may primarily be due to the following features and elements of the heat transfer system 50:

Production of the airflow 200 in the horizontal direction in the second sub-chamber 162 towards the conveyor stack 88 by the airflow producing means 182.

The air permeable configuration of the outer side wall 105 of the conveyor belt 82, such as due to the at least one aperture 148 in the outer side plate 144 (generally forming the outer side wall 105) of belt modules 130 forming the conveyor belt 82, or alternative configurations or materials which provide the outer side wall 105 with air permeability. The air permeable outer side wall 105 enables the airflow 200 in the second sub-chamber 162 outside the conveyor stack 88 to flow through the outer side wall 105 to enter the conveyor stack 88.

However, in certain embodiments, directing the airflow 200 within the second sub-chamber 162 in the horizontal and radial direction to enter the conveyor stack 88 may also be facilitated by at least one of the following features and elements of the heat transfer system 50:

Placement of the airflow producing means 182 in the second sub-chamber 162 and the placement of the airflow drawing means 184 in the first sub-chamber 160 to create the pressure differential between the second sub-chamber 162 and the first sub-chamber 160. As noted above, the pressure differential may cause the airflow 200 to seek a path of travel from the second sub-chamber 162 to the first sub-chamber 160.

As noted above, the top end wall 106 substantially restricting the airflow 200 in a vertical direction from the second sub-chamber 162 through the top opening 100 and directly into the volume of the central space 98 can facilitate directing the airflow 200 in the horizontal and radial direction to enter the conveyor stack 88 through the outer side wall 105, as the airflow 200 seeks alternate paths of travel from the second sub-chamber 162 towards the first sub-chamber 160.

As noted above, the baffle 202 substantially restricting the airflow 200 from flowing directly between the second sub-chamber 162 and the first sub-chamber 160 except within the volume of the central space 98, can facilitate directing the airflow 200 in the horizontal and radial direction to enter the conveyor stack 88 through the outer side wall 105, as the airflow 200 seeks alternate paths of travel from the second sub-chamber 162 towards the first sub-chamber 160.

Still referring to FIGS. 1, 4A and 4B, at least a portion of the airflow 200 within the conveyor stack 88 is then directed in a horizontal and radial direction across the second plurality of tiers 96 of the conveyor stack 88 and through the inner side wall 104 of the conveyor belt 82 to enter the second portion 206 of the volume of the central space 98. Directing the airflow 200 within the conveyor stack 88 in the horizontal and radial direction across the second plurality of tiers 96 and to enter the second portion 206 of the volume of the central space 98 may primarily be due to the following features and elements of the heat transfer system 50:

As noted above, production of the airflow 200 in the horizontal direction in the second sub-chamber 162 towards the conveyor stack 88 by the airflow producing means 182.

The air permeable configuration of the inner side wall 104 of the conveyor belt 82, such as due to the at least one aperture 146 in the inner side plate 142 (generally forming the inner side wall 104) of the belt modules 130 forming the conveyor belt 82, or alternative configurations or materials which provide the inner side wall 104 with air permeability. The air permeable inner side wall 104 enable the airflow 200 received within the conveyor stack 88 to flow through the inner side wall 105 to enter the second portion 206 of the volume of central space 98.

However, in certain embodiments, directing the airflow 200 within the conveyor stack 88 in the horizontal and radial direction across the second plurality of tiers 96 and into the second portion 206 of the volume of the central space 98 may also be facilitated by at least one of the following features and elements of the heat transfer system 50:

As noted above, placement of the airflow producing means 182 in the second sub-chamber 162 and the placement of the airflow drawing means 184 in the first sub-chamber 160 to create the pressure differential between the second sub-chamber 162 and the first sub-chamber 160. As noted above, the pressure differential may cause the airflow 200 to seek a path of travel from the second sub-chamber 162 to the first sub-chamber 160.

In certain embodiments, the conveying portion 107 of the conveyor belt 82 between the inner side wall 104 and the outer side wall 105 of the conveyor belt 82 may restrict airflow 200 in a vertical direction through the conveying portion 107, such as due to the configuration or materials of the central portion 132 of the belt module 130 forming the conveyor belt 82. Restricting the airflow 200 in the vertical direction through the conveying portion 107 can restrict the airflow 200 in the vertical direction between the different tiers of the second plurality of tiers 96 of the conveyor stack 88 in the second sub-chamber 162. Restricting the airflow 200 in the vertical direction through the conveyor stack 88 can facilitate directing the airflow 200 in the horizontal and radial direction across the second plurality of tiers 96 of the conveyor stack 88 and into the second portion 206 of the volume of the central space 98, as the airflow 200 seeks alternate paths of travel from the second sub-chamber 162 towards the first sub-chamber 160.

As noted above, the top end wall 106 substantially restricting the airflow 200 in a vertical direction from the second sub-chamber 162 through the top opening 100 and directly into the volume of the central space 98 can facilitate directing the airflow 200 in the horizontal and radial direction across the second plurality of tiers 96 and into the second portion 206 of the volume of the central space 98, as the airflow 200 seeks alternate paths of travel from the second sub-chamber 162 towards the first sub-chamber 160.

As noted above, the baffle 202 substantially restricting the airflow 200 from flowing directly between the second sub-chamber 162 and the first sub-chamber 160 except within the volume of the central space 98, can facilitate directing the airflow 200 in the horizontal and radial direction across the second plurality of tiers 96 and into the second portion 206 of the volume of the central space 98, as the airflow 200 seeks alternate paths of travel from the second sub-chamber 162 towards the first sub-chamber 160.

Referring now to FIG. 1, at least a portion of the airflow 200 within the second portion 206 of the volume of the central space 98 is then directed in a vertical direction from the second portion 206 of the volume of the central space 98 towards the first portion 204 of the volume of the central space 98. The airflow 200 is thus allowed to vertically flow from the second sub-chamber 162 into the first sub-chamber 160 within the volume of the central space 98. Directing the airflow 200 in the vertical direction from the second portion 206 to the first portion 204 of the volume of the central space 98 may primarily be due to the following features and elements of the heat transfer system 50:

Placement of the airflow producing means 182 in the second sub-chamber 162 and the placement of the airflow drawing means 184 in the first sub-chamber 160 to create the pressure differential between the second sub-chamber 162 and the first sub-chamber 160. As noted above, the pressure differential may cause the airflow 200 to seek a path of travel from the second sub-chamber 162 to the first sub-chamber 160.

The baffle 202 substantially restricting the airflow 200 from flowing in the vertical direction directly between the second sub-chamber 162 and the first sub-chamber 160 except within the volume of the central space 98. Restricting the airflow 200 between the second sub-chamber 162 and first sub-chambers 160 except within the volume of central space 98 generally facilitates the airflow 200 in the vertical direction within the volume of the central space 98 (such as from the second portion 206 of the volume of the central space 98 located in the second sub-chamber 162 to the first portion 204 of the volume of the central space 98 located in the first sub-chamber 160), as the airflow 200 seeks a path of travel from the second sub-chamber 162 towards the first sub-chamber 160.

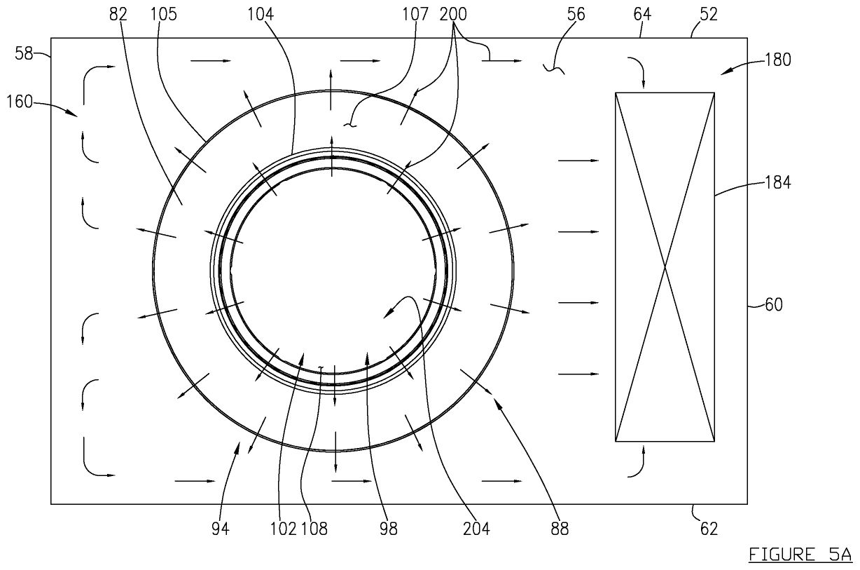

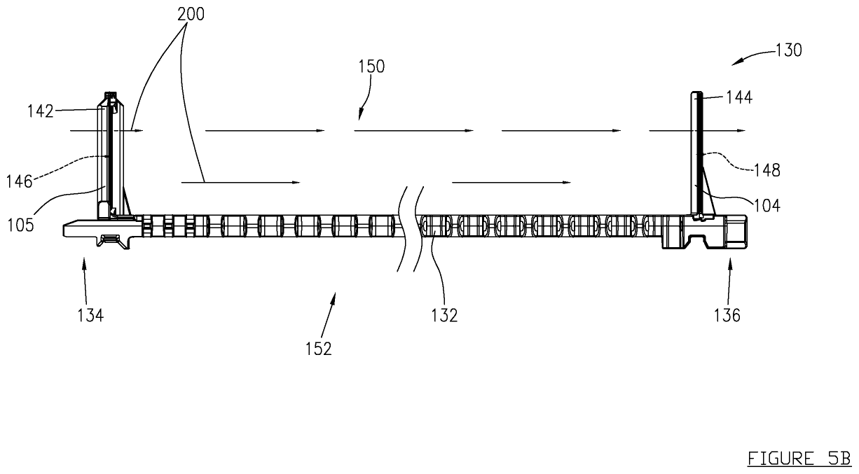

Referring to FIGS. 5A and 5B, a cross-sectional view of the heat transfer system 50 of FIG. 1 at line 5-5 is shown in FIG. 5A, and the path of travel of the airflow 200 across a belt module 130 (described in greater detail above in association with FIG. 3) located in the first sub-chamber 160 (such as located within a tier of the first plurality of tiers 94 of the conveyor stack 88) is shown in FIG. 5B.

Referring to FIGS. 1, 5A and 5B, at least a portion of the airflow 200 within the first portion 204 of the volume of the central space 98 is directed in a horizontal and radial direction through the inner side wall 104 of the conveyor belt 82 to exit the volume of the central space 98. Directing the airflow 200 within the first portion 204 of the volume of the central space 98 in the horizontal and radial direction to exit the volume of the central space 98 may primarily be due to the following features and elements of the heat transfer system 50:

Drawing of the airflow 200 in the horizontal direction in the first sub-chamber 160 away from the conveyor stack 88 by the airflow drawing means 184, which encourages the airflow 200 within the first portion 204 of the volume of the central space 98 to find a path of travel towards the at least one air inlet of the airflow drawing means 184.

The air permeable configuration of the inner side wall 104 of the conveyor belt 82, which enables the airflow 200 within the first portion 204 of the volume of the central space 98 to flow through the inner side wall 104 to exit the volume of the central space 98.

However, in certain embodiments, directing the airflow 200 within the first portion 204 of the volume of the central space 98 in the horizontal and radial direction to exit the volume of the central space 98 may also be facilitated by at least the following feature of the heat transfer system 50:

The bottom end wall 108 positioned at the bottom opening 102 of the conveyor stack 88. The bottom end wall 108 may cause certain portions of the airflow 200 within the volume of the central space 98 which flow to contact the bottom end wall 108 to be deflected back into the volume of the central space 98. The bottom end wall 108 also restrict the airflow 200 within the volume of the central space 98 from flowing in a vertical direction directly from the volume of the central space 98 into the first sub-chamber 160. Deflecting the airflow 200 back into the volume of the central space 98 and preventing the airflow 200 from entering the first sub-chamber 104 directly from the volume of the central space 98 can facilitate directing the airflow 200 in the horizontal and radial direction to exit the first portion 204 of the volume of the central space 98, as the airflow 200 seeks to find alternate paths of travel towards the at least one air inlet of the airflow drawing means 184.

Still referring to FIGS. 1, 5A and 5B, at least a portion of the airflow 200 within the conveyor stack 88 is then directed in a horizontal and radial direction across the first plurality of tiers 94 of the conveyor stack 88 and through the outer side wall 105 of the conveyor belt 82 to exit the conveyor stack 88. Directing the airflow 200 in the horizontal and radial direction across the first plurality of tiers 94 and to exit the conveyor stack 88 may primarily be due to:

Drawing of the airflow 200 in the horizontal direction in the first sub-chamber 160 away the conveyor stack 88 by the airflow drawing means 184, which encourages the airflow 200 in the conveyor stack 88 to find a path of travel towards the at least one air inlet of the airflow drawing means 184.

The air permeable configuration of the outer side wall 105 of the conveyor belt 82, which enables the airflow 200 within the conveyor stack 88 in the first sub-chamber 162 to flow through the outer side wall 105 to exit the conveyor stack 88.

However, in certain embodiments, directing the airflow 200 within the conveyor stack 88 in the horizontal and radial direction across the first plurality of tiers 94 and through the outer side wall 105 to exit the conveyor stack 88 may also be facilitated by at least one of the following features or elements of the heat transfer system 50:

As noted above, the conveying portion 107 of the conveyor belt 82 between the inner side wall 104 and the outer side wall 105 of the conveyor belt 82 may restrict airflow 200 in the vertical direction through the conveying portion 107. Restricting the airflow 200 in the vertical direction through the conveying portion 107 can restrict the airflow 200 in the vertical direction between the different tiers of the first plurality of tiers 94 of the conveyor stack 88 in the first sub-chamber 162. Restricting the airflow 200 in the vertical direction between different tiers of the first plurality of tiers 94 can facilitate directing the airflow 200 in the horizontal and radial direction across the first plurality of tiers 94 and through the outer side wall 105 to exit the conveyor stack 88, as the airflow 200 seeks alternate paths of travel towards the at least one air inlet of the airflow drawing means 184.

As noted above, the bottom end wall 108 substantially restricting the airflow 200 in a vertical direction from the volume of the central space 98 directly into the first sub-chamber 160 can facilitate directing the airflow 200 within the conveyor stack 88 in the horizontal and radial direction across the first plurality of tiers 94 and through the outer side wall 105 to exit the conveyor stack 88, as the airflow 200 seeks alternate paths of travel towards the at least one air inlet of the airflow drawing means 184.

Referring now to FIGS. 1 and 5A, within the first sub-chamber 160, at least a portion of the airflow 200 exiting the conveyor stack 88 may be drawn by the airflow drawing means 184 horizontally from the conveyor stack 88 towards the at least one air inlet of the airflow drawing means 184. Drawing the airflow 200 in the horizontal direction away from the conveyor stack 88 may primarily be due to a vacuum or other negative pressure created by the airflow drawing means 184 in the first sub-chamber 160, which encourages the airflow 200 within the first sub-chamber 160 to find a path of travel towards the at least one air inlet of the airflow drawing means 184. However, in certain embodiments, directing the airflow 200 in the horizontal direction away from the conveyor stack 88 may also be facilitated by at least one of the following features and elements of the heat transfer system 50:

Certain portions of the airflow 200 exiting the conveyor stack 88 may flow to contact the first end wall 58 of the housing 52, certain other portions of the airflow 200 may contact the first side wall 62 and the second side wall 64 of the housing 52, and certain other portions of the airflow 200 may contact the bottom wall 56 of the housing 52. However, the walls 58, 62, 64, and 56 may deflect the airflow 200 contacting the walls 58, 62, 64 and 56 back into the first sub-chamber 160, which may facilitate the drawing of the airflow 200 in the first sub-chamber 160 away from the conveyor stack 88 and towards the at least one air inlet of the airflow drawing means 184.

As noted above, the central placement of the conveyor stack 88 within the chamber 54 may cause even deflection of the airflow 200 which contacts the walls 58, 62, 64 and 56 back into the first sub-chamber 160, which may facilitate the even deflection of the airflow 200 back into the first sub-chamber 160. The airflow 200 remaining in the first sub-chamber 160 may be drawn in the horizontal direction towards the at least one air inlet of the airflow drawing means 184.

The bottom end wall 108 may further deflect certain portions of the airflow 200 in the first sub-chamber 160 which flow to contact the bottom end wall 108 back into the first sub-chamber 160, such as towards the bottom wall 56 of the housing 52 for example. The bottom end wall 108 can thus also prevent the airflow 200 in the first sub-chamber 162 from flowing back into the volume of the central space 98. Deflecting the airflow 200 back into the first sub-chamber 160 and preventing the airflow 200 from entering the volume of the central space 98 can cause the airflow 200 to remain within the first sub-chamber 160. The airflow 200 remaining in the first sub-chamber 160 may be drawn in the horizontal direction towards the at least one air inlet of the airflow drawing means 184.

The baffle 202 of the heat transfer system 50 is configured to substantially restrict the airflow 200 directly between the first sub-chamber 160 and the second sub-chamber 162 except within the volume of the central space 98. Certain portions of the airflow 200 in the first sub-chamber 160 which flow to contact the baffle 202 may be deflected from the baffle 202 back into the first sub-chamber 160, such as towards the bottom wall 56 of the housing 52 for example. Deflecting the airflow 200 back into the first sub-chamber 160 and preventing the airflow 200 from entering the second sub-chamber 162 directly from the first sub-chamber 160 can cause the airflow 200 to remain within the first sub-chamber 160. The airflow 200 remaining in the first sub-chamber 160 may be drawn in the horizontal direction towards the at least one air inlet of the airflow drawing means 184.

As noted above, in some embodiments, the conveyor system 80 may include a driving drum located within the central space 98 of the conveyor stack 88 which engages the inner wall 104 the conveyor belt 82 to rotate the conveyor belt 82 along a travel path of the conveyor belt 82. One embodiment of such a driving drum is shown generally at 250 in FIG. 6.

The driving drum 250 may include a plurality of drive bars 252 to facilitate engagement of the inner wall 104 of the conveyor belt 82. For example, each drive bar of the plurality of drive bars 252 may engage a contact surface (resulting from a recess or a lug) on the inner wall of the conveyor belt 82, and each drive bar of the plurality of drive bars 252 may engage multiple different tiers of the plurality of tiers 86 of the conveyor stack 88 along the drive bar's vertical length 254. Rotation of the driving drum 250 may drive the conveyor belt 82 along the travel path of the conveyor belt 82 and through the conveyor stack 88. For example, in embodiments where the travel path of the conveyor belt 82 involves traveling from the lower input 84, into the conveyor stack 88, and exiting at the upper output 90, rotation of the driving drum 250 may drive the conveyor belt 82 upwards through the conveyor stack 88 from the first plurality of tiers 94 (generally comprising the lower tiers) towards the second plurality of tiers 96 (generally comprising the upper tiers). In other embodiments where the travel path of the conveyor belt 82 is in the reverse direction, namely traveling from the upper output 90, into the conveyor stack 88, and exiting at the lower input 84, the rotation of the driving drum 250 may drive the conveyor belt 82 downwards through the conveyor stack 88 from the second plurality of tiers 96 to the first plurality of tiers 94.

The driving drum 250 may further include a plurality of spaces 256 between and separating different drive bars of the plurality of drive bars 252. The plurality of spaces 256 and the plurality of drive bars 252 generally form a lateral wall 258 of the driving drum 250. The plurality of spaces 256 provide the lateral wall 258 of the driving drum 250 with a substantially air permeable configuration. In other embodiments, the driving drum 250 may have other features, or may be formed of other materials, which provide the lateral wall 258 with a substantially air permeable configuration. For example, rather than the plurality of spaces 256, the plurality of drive bars 252 may be separated by a mesh or a material having a plurality of apertures.

The air permeable lateral wall 258 of the driving drum 250 cooperates with the air permeable inner side wall 104 and the air permeable outer side wall 105 of the conveyor belt 82 to enable the airflow 200 to in the horizontal and radial direction from outside of the conveyor stack 88 into the second portion 206 of the volume of the central space 98 in the second sub-chamber 162 (shown in FIGS. 1 and 4A), and in the horizontal and radial direction from the first portion 204 of the volume of the central space 98 through the conveyor stack 88 to the outside of the conveyor stack 88 in the first sub-chamber 160 (shown in FIGS. 1 and 5A). For example, in the second sub-chamber 162, at least a portion of the airflow 200 within the conveyor stack 88 may be directed to enter the second portion 206 of the volume of the central space 98 through both the inner side wall 104 of the conveyor belt 82 and the lateral wall 258 of the driving drum 250. Similarly, in the first sub-chamber 160, at least a portion of the airflow 200 within the first portion 204 of the central space 98 may be directed to exit the first portion 204 of the central space 98 through both the lateral wall 258 of the driving drum 250 and the inner side wall 104 of the conveyor belt 82.

The driving drum 250 may further include a top opening 260 and a bottom opening 262 which may generally align with the top opening 100 (shown in FIGS. 1 and 4A) and the bottom opening 102 (shown in FIGS. 1 and 5A) of the conveyor stack 88. As such, in embodiments where the heat transfer system 50 includes at least one of the top end wall 106 positioned at the top opening 100 configured to substantially restrict any airflow through the top opening 100, and the bottom end wall 106 positioned at the bottom opening 102 configured to substantially restrict any airflow through the bottom opening 102, the top and bottom end walls 106, 108 may also substantially restrict any airflow through the top and bottom openings 260, 262 of the driving drum 250. The top and bottom openings 260 and 262 of the driving drum 250 may thus generally cooperate with the top and bottom openings 100 and 102 and the top and bottom end walls 106 and 108 of the conveyor stack 88 to restrict the airflow 200 from vertically flowing directly from the second sub-chamber 162 into the volume of the central space 98 and from vertically flowing directly from the volume of the central space 98 into the first sub-chamber 160.

Generally, the embodiments of the heat transfer system configured to alter a temperature of a product described herein include features which allow such heat transfer systems to generate and direct horizontal and radial airflow through a conveyor stack formed by a conveyor belt. For example, the conveyor belt having both an air permeable outer side wall and an air permeable inner side wall can allow horizontal airflow through the conveyor stack formed by the conveyor belt.

Further, embodiments of the heat transfer system which include a conveyor stack placed within a chamber having a first sub-chamber housing a first plurality of tiers of the conveyor stack and a second sub-chamber housing a second plurality of tiers of the conveyor stack can allow horizontal and radial airflow in two different directions, such as towards the conveyor stack in one of the first and second sub-chambers and away from the conveyor stack in one of the first and second sub-chambers. Horizontal and radial flow in two different directions may improve efficiency of the heat transfer system at altering the temperature of a product carried on the conveyor belt.

While the present subject matter has been described above in connection with illustrative embodiments, as shown in the various figures, it is to be understood that other similar embodiments may be used or modifications and additions may be made to the described embodiments for performing the same function without deviating therefrom. Further, all embodiments disclosed are not necessarily in the alternative, as various embodiments may be combined to provide the desired characteristics. While specific embodiments have been described and illustrated, such embodiments should be considered illustrative of the subject matter described herein and not as limiting the claims as construed in accordance with the relevant jurisprudence.

1-23 (canceled)

24. A heat transfer system configured to alter a temperature of product with airflow, the system comprising:
a conveyor belt configured to carry the product, wherein the conveyor belt has an air permeable outer side wall and an air permeable inner side wall and forms a conveyor stack having a plurality of tiers and a central space with a volume, wherein the conveyor stack is positioned in a chamber such that a first portion of the volume of the central space and a first plurality of tiers of the plurality of tiers are located in a first sub-chamber of the chamber and a second portion of the volume of the central space and a second plurality of tiers of the plurality of tiers are located in a second sub-chamber of the chamber; and
generating means configured to generate the airflow in the chamber, wherein the generating means is configured to:
produce, in the second sub-chamber, the airflow in a horizontal direction towards the conveyor stack such that the airflow flows in a horizontal and radial direction across the second plurality of tiers to enter the second portion of the volume of the central space; and
draw, in the first sub-chamber, the airflow in a horizontal direction away from the conveyor stack such that the airflow flows in a horizontal and radial direction to exit the first portion of the volume of the central space across the first plurality of tiers.

25. The heat transfer system of claim 24, further comprising at least one of a top end wall configured to restrict the airflow in a vertical direction through a top opening of the conveyor stack and a bottom end wall configured to restrict the airflow in a vertical direction through a bottom opening of the conveyor stack.

26. The heat transfer system of claim 25, wherein the top end wall further restricts the airflow in a vertical direction from the second sub-chamber directly into the volume of the central space.

27. The heat transfer system of claim 25, wherein the bottom end wall further restricts the airflow in a vertical direction from the volume of the central space directly into the first sub-chamber.

28. The heat transfer system of claim 24, wherein the generating means is further configured to cause, within the volume of the central space, the airflow in a vertical direction from the second portion of the volume of the central space in the second sub-chamber towards the first portion of the volume of the central space in the first sub-chamber.

29. The heat transfer system of claim 24, wherein the first sub-chamber and the second sub-chamber are defined by a baffle coupled to the conveyor stack and configured to substantially restrict the airflow in a vertical direction directly between the first sub-chamber and the second sub-chamber except within the volume of the central space.

30. The heat transfer system of claim 24, wherein the conveyor belt is formed from a plurality of belt modules, wherein each belt module of the plurality of belt modules comprises:
a central portion configured to carry the product, wherein the central portion extends between an inner side of the belt module and an outer side of the belt module;
an inner side plate coupled the central portion proximate the inner side edge; and
an outer side plate coupled the central portion proximate the outer side edge.

31. The heat transfer system of claim 30, wherein the outer side plate and the inner side plate each define at least one aperture to enable the airflow in the horizontal and radial direction across the plurality of tiers.

32. The heat transfer system of claim 30, wherein the outer side plate of the plurality of belt modules form the air permeable outer side wall of the conveyor belt.

33. The heat transfer system of claim 30, wherein the inner side plate of the plurality of belt modules form the air permeable inner side wall of the conveyor belt.

34. The heat transfer system of claim 30, wherein the central portion has an air permeable configuration to facilitate the airflow in a vertical direction through the central portion between different tiers of the plurality of tiers.

35. The heat transfer system of claim 30, wherein the central portion has an air impermeable configuration to substantially restrict the airflow in a vertical direction through the central portion between different tiers of the plurality of tiers.

36. The heat transfer system of claim 30, further comprising a baffle coupled to the conveyor stack to substantially restrict the airflow in a vertical direction at an interface between the second plurality of tiers and the first plurality of tiers.

37. The heat transfer system of claim 24, wherein the generating means comprises:
producing means located in the second sub-chamber and configured to produce the airflow in the horizontal direction towards the conveyor stack;
drawing means located in the first sub-chamber and configured to draw the airflow in the horizontal direction away from the conveyor stack.

38. The heat transfer system of claim 24, further comprising a driving drum positioned within the central space and configured to engage the inner side wall of the conveyor belt, wherein the driving drum comprises an air permeable side wall configured to cooperate with the air permeable inner side wall and the air permeable outer side wall of the conveyor belt to facilitate the airflow in the horizontal and radial direction across the plurality of tiers.

39. A method of assembling a heat transfer system configured to alter a temperature of a product using airflow, the method comprising:
positioning a conveyor stack formed by a plurality of tiers of a conveyor belt configured to carry the product, the conveyor belt including an air permeable outer side wall and an air permeable inner side wall and the conveyor stack having a central space with a volume, in a chamber such that a first portion of the volume of the central space and a first plurality of tiers of the plurality of tiers are located in a first sub-chamber of the chamber and a second portion of the volume of the central space and a second plurality of tiers of the plurality of tiers are located in a second sub-chamber of the chamber; and
positioning generating means configured to generate the airflow in the chamber proximate the conveyor stack, wherein the generating means is configured to:
produce, in the second sub-chamber, the airflow in a horizontal direction towards the conveyor stack such that the airflow flows in a horizontal and radial direction across the second plurality of tiers to enter the second portion of the volume of the central space; and
draw, in the first sub-chamber, the airflow in a horizontal direction away from the conveyor stack such that the airflow flows in a horizontal and radial direction to exit the first portion of the volume of the central space across the first plurality of tiers.

40. The method of claim 39, further comprising coupling a baffle to the conveyor stack, wherein the baffle defines the first and second sub-chambers and substantially restricts the airflow in a vertical direction directly between the first sub-chamber and the second sub-chamber except within the volume of the central space.

41. A method of altering a temperature of a product carried on a conveyor belt having an air permeable outer side wall and an air permeable inner side wall and forming a conveyor stack having a plurality of tiers and a central space with a volume, wherein the conveyor stack is positioned in a chamber, the method comprising:
producing, in a second sub-chamber of the chamber, the airflow in a horizontal direction towards the conveyor stack such that the airflow flows in a horizontal and radial direction across a second plurality of tiers of the plurality of tiers to enter a second portion of the volume of the central space; and
drawing, in a first sub-chamber of the chamber, the airflow in a horizontal direction away from the conveyor stack such that the airflow flows in a horizontal and radial direction to exit a first portion of the volume of the central space across a first plurality of tiers of the plurality of tiers.

42. The method of claim 41, further comprising substantially restricting the airflow in a vertical direction through a top opening of the conveyor stack in the second sub-chamber to facilitate the airflow in the horizontal and radial direction across the second plurality of tiers to enter the second portion of the volume of the central space.

43. The method of claim 41, further comprising substantially restricting the airflow in a vertical direction through a bottom opening of the conveyor stack in the first sub-chamber to facilitate the airflow in the horizontal and radial direction to exit the first portion of the volume of the control space across the first plurality of tiers.

44. The method of claim 41, further comprising causing, within the volume of the central space, the airflow in a vertical direction from the first portion of the volume towards the second portion of the volume.

45. The method of claim 41, further comprising coupling a baffle to the conveyor stack to define the first sub-chamber and the second sub-chamber and to substantially restrict the airflow in a vertical direction directly between the first sub-chamber and the second sub-chamber except within the volume of the central space.

46. The method of claim 41, wherein the generating means is configured to:
produce the airflow in the horizontal direction towards the conveyor stack by increasing a pressure of air in the second sub-chamber, and
draw the airflow in the horizontal direction away from the conveyor stack by decreasing a pressure of air in the first sub-chamber.
